(19) United States
(12) Patent Application Publication
(10) Pub. No.: US 2010/0201525 A1
(43) Pub. Date: Aug. 12, 2010

(54) METHOD AND SYSTEM FOR DETECTING AND DETERRING ANIMAL INTRUDERS

(75) Inventors: Ofer Bahat, Zichron Yaakov (IL); Noah Satat, Hadera (IL)

Correspondence Address: THE NATH LAW GROUP, 112 South West Street, Alexandria, VA, 22314, US

(73) Assignee: BIRDSVISION LTD., Zichron Yaakov (IL)

(21) Appl. No.: 12/452,609

(22) PCT Filed: Jul. 13, 2008
(86) PCT No.: PCT/IL2008/000967

§ 371 Date: Mar. 16, 2010

Related U.S. Application Data
(60) Provisional application No. 60/929,841, filed on Jul. 13, 2007.

(51) Int. Cl. G08B 23/00; E04B 1/72

(52) U.S. Cl. 340/573.2; 52/101

(57) ABSTRACT

In a system for deterring intruding animals in a surveillance space or surveillance area, one or more detectors monitor the surveillance space or area for the presence of intruding animals. Each detector generates a signal that is analyzed by a processor in order to determine whether any intruding animals are located in the space under surveillance. When an intruding animal is detected, the processor determines an azimuth and elevation of the intruding animal. The processor then aims deterrence devices at the intruding animal and activates the aimed deterrence devices.

### FIELD OF THE INVENTION

This invention relates to methods and systems for deterring animal intruders.

### BACKGROUND OF THE INVENTION

Intruding birds as well as other animals (e.g. mammals), often pose problems and damages at such locations as electricity infrastructure (e.g. electric poles and electric lines), windfarms, airfields, agricultural areas, fishponds, high buildings and solar power production facilities and infrastructure (both thermal and photovoltaic). Acoustic devices and laser beams have been used in conjunction with detecting devices at unwanted animal intruders in order to startle the animals and cause them to flee. Both the deterring acoustic devices and laser beam operations are triggered by the detection of the intruding animals, and are operated in a random modulation in order to prevent the animals from becoming habituated to it, which would impair the effectiveness of the deterring devices in startling the animals, and causing them to flee.

U.S. Pat. No. 5,602,523 utilizes ultrasonic sounds to scare off deer and other wildlife.

U.S. Pat. No. 5,892,446 to Reich utilizes a heat and motion sensor to detect an intruding animal. When an intruding animal is detected, a radio and a light source are activated to scare off the animal. The use of a radio ensures that the sound emanating from the device is continually changing.

### SUMMARY OF THE INVENTION

The present invention provides a system and method for detecting intruding animals and causing them to flee. The invention may be used to deter any type of animal intruder such as birds, deer, gazelle, and so on. The system of the invention may be deployed, for example, adjacent to elevated electric lines to prevent birds from roosting on the lines and utility poles. As another example, the system of the invention may be deployed at or near an airport to prevent birds and other animal intruders from endangering flight safety.

The system of the invention comprises a detecting unit comprising one or more detectors that monitor a surveillance space or area for the presence of intruding animals. The detectors may include, for example, a video camera (CCD), a thermal imaging camera which obtains IR image of the space, an ultraviolet (UV) camera, Radar which detects and tracks moving animals in the space, or an antenna and microphone combination which detects animal sounds.

Each detector generates a respective signal that is analyzed by a processor located at a command and control center in order to determine whether or not any intruding animals are located in the surveillance space. The processor is also configured, when an intruding animal is detected, to determine from the signals the azimuth and elevation of the intruding animal relative to the position of the system. The processor then activates an aiming mechanism that aims one or more of the deterrence devices at the intruding animal and to activate the deterrence devices in order to startle the intruding animal and cause it to flee in order to create a sterile zone, for example, e.g surrounding an airfield or electric pole.

The deterrence devices include a laser that is aimed by the aiming mechanism at an intruding animal. The deterrence devices may include an acoustic device that preferably produces random noise range that changes randomly among a plurality of modulations. Additionally or alternatively, the acoustic deterrence device may generate storm and gale weather sounds, intensified and repeated in random sequences.

In one preferred embodiment, the detecting unit comprises two or more detectors of different types. Use of two or more detector types allows simultaneous detection of different animal species. Moreover, use of two or more detector types enhances the robustness of the system, so that the system can operate automatically 24/7, under varying environmental conditions, such as night and day, or varying weather conditions. In another preferred embodiment, the deterrence unit comprises two or more different deterrence devices of different types. Use of two or more deterrence device types allows deterrence under varying environmental conditions, and also allows simultaneous deterrence of different animal species and decreases the likelihood of the animals becoming habituated to the deterrence.

In a preferred embodiment, the processor of the system is configured to continuously prioritize targets when more than one intruding animals are detected simultaneously in the surveillance space. Prioritization of the intruding animals ranks the intruding animals in accordance with the risk of danger or damage that each intruding animal poses. In this embodiment, the processor aims one or more of the deterrence devices at the intruding animal or animals having the highest prioritization (the animal or animals posing the greatest risk of danger or damage). The process of prioritization may involve, for example, the location of the animal, its direction and speed of its movement, the azimuth of its movement and the predicted time remaining until the animal is expected to cause damage. Another prioritizing factor is the density of intruding animals at a particular location (azimuth and elevation sector).

Thus, in its first aspect, the invention provides a system for deterring intruding animals in a surveillance space or surveillance area comprising:
(a) one or more detectors monitoring the surveillance space or area for the presence of intruding animals, each detector generating a signal;
(b) one or more deterrence devices, at least one of the deterrence devices being positionable;
(c) a processor configured to:
   analyze the one or more detector signals in order to determine whether or not any intruding animals are located in the space under surveillance;
   when an intruding animal is detected, to determine from the one or more detector signals; an azimuth and elevation of the intruding animal relative to a position of the system;
   position one or more of the positionable deterrence devices to aim the one or more of the positionable deterrence devices at the intruding animal; and
   activate the one or more aimed deterrence devices.

In another of its aspects, the invention provides a method for deterring intruding animals in a surveillance space or surveillance area comprising:
(a) using one or more detectors to monitor the surveillance space or area for the presence of intruding animals, each detector generating a signal;
(b) analyzing the one or more detector signals in order to determine whether or not any intruding animals are located in the space under surveillance;
(c) when an intruding animal is detected, determining from the one or more detector signals an azimuth and elevation of the intruding animal;
(d) aiming one or more positionable deterrence devices at the intruding animal; and
(e) activating the one or more aimed deterrence devices.

The invention also provides a system for deterring intruding animals in a surveillance space or surveillance area comprising:
(a) two or more detectors monitoring the surveillance space or area for the presence of intruding animals, each detector generating a signal;
(b) one or more deterrence devices; and
(c) a processor configured to analyze the two or more detector signals in order to determine whether or not any intruding animals are located in the space under surveillance.

The invention still further provides a device for preventing birds from perching or roosting comprising:
(a) an axle; and
(b) cylindrical tube coaxial with the axle, the cylindrical tube being rotatable around the axis.

The invention also provides a device for preventing birds from perching or roosting, comprising:
(a) a flexible sheet;
(b) one or more pressure sensors associated with the flexible sheet;
(c) one or more activation units, each activation unit including:
   a helical spring having an end in contact with the flexible sheet;
   an electrical motor configured to generate motion of the helical spring when one or more of the pressure sensors are activated.

The invention still further provides a device for preventing birds from perching or roosting, comprising a rack containing a plurality of balls.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a system for deterring intruding animals in accordance with one embodiment of the invention deployed near utility wires;

FIG. 2 shows a system for deterring intruding animals in accordance with one embodiment of the invention;

FIG. 3 shows a system for deterring intruding animals in accordance with one embodiment of the invention deployed in and adjacent to an airport;

FIG. 4 shows a device for preventing birds from perching;

FIG. 5 shows a second device for preventing birds from perching; and

FIG. 6 shows another device for preventing birds from perching or roosting, comprising a rack containing a plurality of balls.

### DETAILED DESCRIPTION OF EMBODIMENTS

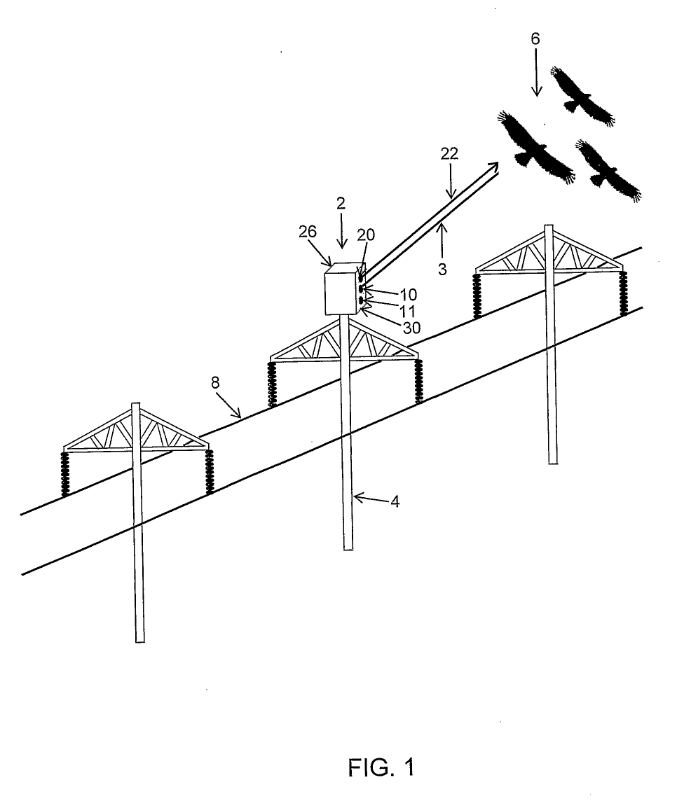

FIG. 1 shows a system 2 for detecting intruding animals and causing them to flee, in accordance with one embodiment of the invention. The system 2 is shown in FIG. 1 installed at the top of a utility pole 4 in order to prevent birds 6 from approaching and roosting or perching on the pole or on adjacent utility wires 8. This is by way of example only, it being evident that the system 2 may be installed in any setting where animal intruders of any species pose a problem.

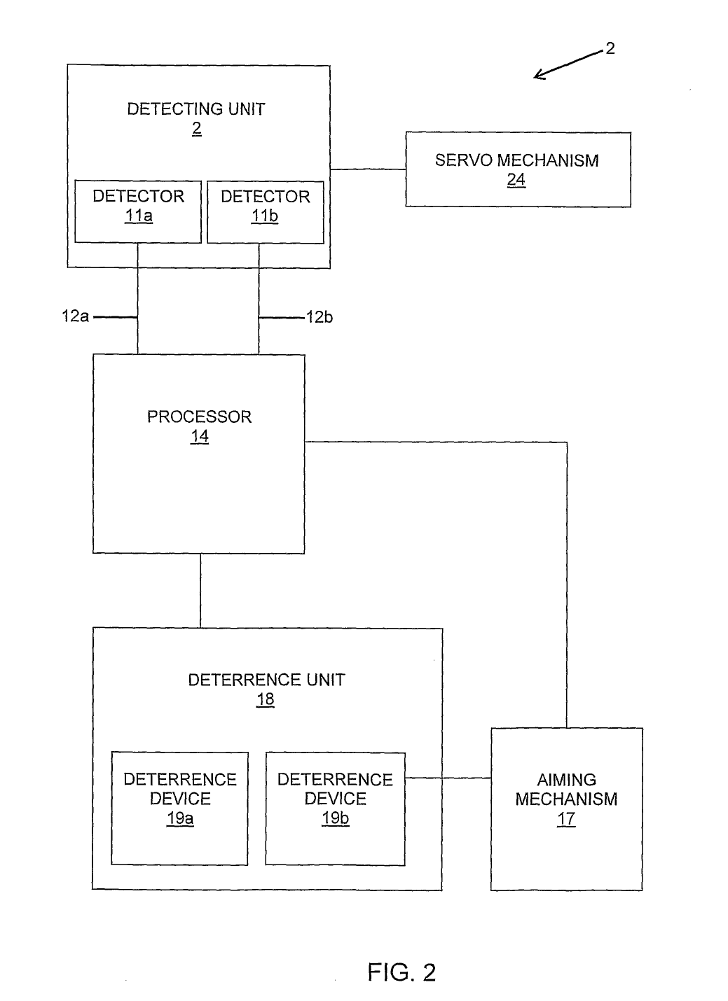

The system 2 is shown schematically in FIG. 2. The system 2 comprises a detecting unit 10 comprising one or more detectors 11 monitoring a surveillance space or area for the presence of intruding animals. Two detectors, 11a and 11b, are shown in FIG. 2. This is by way of example only, and the detecting unit may comprise any number of detectors. The detectors may include, for example, a video camera (CCD) which obtains images of the space, a thermal imaging camera which obtains IR image of the space. An ultraviolet (UV) camera having a sensitivity in the range of 320 to 380 nm (peak sensitivity in the range of 350 to 360 nm) may be used for the detection of such animal intruders as birds, deer, and gazelle. Alternatively, the detectors may include Radar which detects and tracks moving animals in the space, or an antenna and microphone combination which detects animal sounds. In another embodiment, an acoustic device is used for detection. Bird wing flapping, for example, typically has a frequency in the range of 2-20 Hz and can be detected using an appropriately tuned microphone. A phased array of about 25 microphones can be used to calculate the azimuth and elevation of wing flap signals.

Each detector generates a respective signal 12 that is input to a processor 14 for analysis. The processor 14 is configured to analyze the signals 12 in order to determine whether or not any intruding animals are located in the space under surveillance by the detecting unit 10. The processor is also configured, when an intruding animal is detected by the processor 14, to determine from the signals 12 the azimuth and elevation of the intruding animal relative to the position of the system 2. The processor may also be configured to determine the distance of the system 2 to the intruding animal, for example, if the detecting unit 10 includes radar or two or more cameras viewing the space stereoscopically. The processor 14 then sends a signal 16 to a deterrence unit 18. The deterrence unit 18 comprises one or more deterrence devices 19. Two deterrence devices, 19a and 19b, are shown in FIG. 2. This is by way of example only, and the detecting unit may comprise any number of deterrence devices.

At least one of the deterrence devices 19 is positionable by an aiming mechanism 17. The processor 14 activates the aiming mechanism 17 to aim one or more of the positionable deterrence devices 19 at the intruding animal. After aiming the deterrence devices 19 at the intruding animal, the processor 14 activates the deterrence devices 19 in order to startle the intruding animal 6 (see FIG. 1) and cause it to flee. In one embodiment, the processor activates the deterrent devices for a predetermined amount of time. In another embodiment, the processor activates the deterrence devices until the intruding animal has fled the surveillance space. The aiming mechanism may be, for example, a servo mechanism upon which the positionable deterrence devices are mounted.

In one preferred embodiment, the positionable deterrence devices 19 include a laser that is aimed by the aiming mechanism 17 at the intruding animal. The laser may be either a single or multiple beam laser. The laser beam or beams may be aimed at the azimuth and elevation of the detected intruding animal. In a multidirectional mode, the laser beam is rapidly scanned between selected azimuths and elevations to create a multidirectional coverage including the azimuth and elevation of the detected intruding animal. For aiming a laser, the aiming mechanism 17 may include a mirror 18 which is activated by the processor to aim a stationary laser at the detected intruding animal. After the laser source has been aimed at the intruding animal, the processor activates the laser so that a laser beam 22 is directed at the intruding animal 6, in order to startle the intruding animal 6 and cause it to flee. The laser can be transmitted in a constant wave (CW) mode or in a pulse mode. In the CW mode, the laser is continuously generated while aimed at the intruding animal. In the pulse mode, the pulse repetition intervals (PRI) of the transmitted laser can be constant or may have a random modulation or change according to a preprogrammed pattern to avoid habituation by the targeted animal. This pattern is determined and controlled by the processor. The intensity of the laser beam is selected to be sufficiently high to startle the animals to be driven away, while not causing irreversible damage to the animal's eye or any other body part. The laser source may consist of one or more LEDs. The laser source or sources are preferably provided with an optical mirror system to produce one or more laser beam 22 of a desired cross-sectional area and shape, as required in any application.

The laser beams may have fixed wavelength, for example, in the range of 320-900 nanometer. Alternatively, a wavelength shift among preprogrammed wavelengths in the range of 320-900 nanometers may be used.

The deterrence devices may include an acoustic device that may be operated using a single channel aimed at the intruding animal or in a multiple channel mode. A multiple channel mode utilizes a plurality of frequencies each of which can operate with different modulations that change in a random order. The signals produced by the acoustic unit can be transmitted in a constant wave mode (CW), pulsed with fixed intervals or with randomly changing intervals. The acoustic transmission may be transmitted by a multi-directional Phased Array Antenna, in a fixed beam, or scanned among a plurality of different beams, where each beam has a different azimuth and elevation degrees. The use of a specific beam is determined by the relative angle (in azimuth and elevation) to the intruding animal, as measured by the system 2. The acoustic device for deterrence may have peak sensitivity in the range of 10-50 Hz and constructed of tube and fan. The apical angle of the conical area of transmission is preferably around 60°. Preferably, the acoustic deterrence device produces random noise in this frequency range that changes randomly among a plurality of modulations, for example, 1000 different modulations. Additionally or alternatively, the acoustic deterrence device may generate storm and gale weather sounds, intensified and repeated in random sequences.

The detecting unit 10 may be stationary, in which case the detecting unit 10 is preferably provided with wide-angle coverage, up to 360°. Alternatively, the detecting unit 10 may be mounted on a servo mechanism 24, in order to allow the detecting unit 10 to scan the surveillance space. In this case, the movement of the detecting unit 10 is under the control of the processor 14, which activates the servo mechanism 24 according to a predetermined cyclic pattern of movement. When an intruding animal is detected by the processor 14 in an image obtained by the detecting unit 10, the instantaneous position of the detecting unit 10 at the time the image was obtained is used by the processor to determine the azimuth and elevation 3 from the system 2 to the intruding animal. In another embodiment, the detecting unit 10 and the positionable deterrence devices 19 are mounted on a common servo mechanism, so that the positionable deterrence devices and the detecting unit move in unison and are thus always aimed in the same direction (bore sighted).

The system 2 is maintained in a weather proof housing 26. The housing 26 may include a transparent front panel 30 to allow the detecting unit 10 to obtain images of the surveillance space while being contained inside the housing 26, and to allow a laser beam 22 to propagate from the laser source 20 towards the intruding animal 6 while the laser source is inside the housing 26.

The system may be powered by either current electrical standard supplied, or by a battery. The battery may be rechargeable from solar panel.

In one preferred embodiment, the detecting unit 2 comprises two or more detectors 11 of different types. Use of two or more detector types allows simultaneous detection of different animal species. Moreover, use of two or more detector types enhances the robustness of the system 2, so that the system 2 can operate under varying conditions, such as night and day, or varying weather conditions. In another preferred embodiment, the deterrence unit 18 comprises two or more different deterrence devices 19 of different types. Use of two or more deterrence device types allows simultaneous deterrence of different animal species and decreases the likelihood of the animals becoming habituated to the deterrence.

In a preferred embodiment, the processor 14 is configured to continuously prioritize targets when more than one intruding animals are detected simultaneously in the surveillance space. Prioritization of the intruding animals ranks the intruding animals in accordance with the risk of danger or damage that each intruding animal poses. In this embodiment, the processor 14 activates the aiming mechanism 17 in order to aim one or more of the positionable deterrence devices at the intruding animal or animals having the highest prioritization (the animal or animals posing the greatest risk of danger or damage). The process of prioritization may involve, for example, the location of the animal, its direction and speed of its movement, the azimuth of its movement and the predicted time remaining until the animal is expected to cause damage. Another prioritizing factor is the density of intruding animals at a particular location (azimuth and elevation sector). The processor may be configured to track the animals over a time period by recording animal locations over the time period.

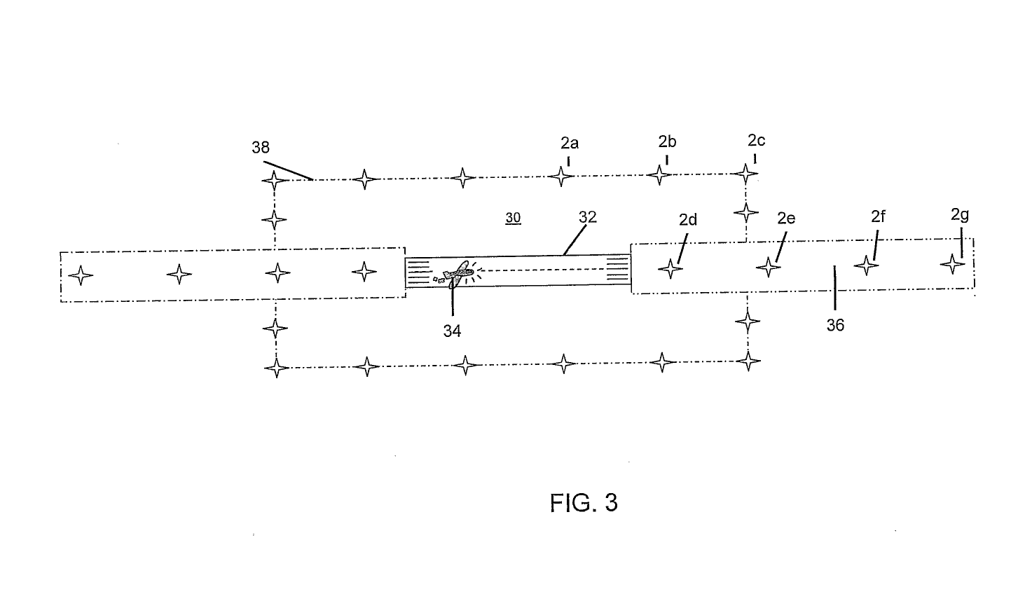

FIG. 3 shows an array of the systems 2 of the invention deployed near an airport 30 to scatter birds and other intruders. Some of the systems 2 (the systems 2a, 2b, and 3c) are deployed along the perimeter 38 of the airport 30 in order to scatter intruding animals, especially birds, and prevent them from posing a danger to aircraft 34 during take-off or landing. Some of the systems 2 (the systems 2d, 2e, 2f, and 2g) are deployed in a take-off and landing corridor 36 at either end of a runway 32 and aligned with the runway 32, in order to scatter intruding animals in the take-off and landing corridor 36 (indicated by broken lines in FIG. 3) contiguous with the end of the runway 32. The system 2d is located within the perimeter 38 of the airport 30. The systems 2e, 2f and 2g are located outside the perimeter 38 of the airport 30. The inventors have found that deploying the system 2 along a flight corridor for about 10 miles each side from the end of a runway significantly enhances aircraft safety by keeping the corridor substantially free of birds. When birds have been located in the flight corridor, this information can be combined with information on the location of aircraft in the corridor to generate an image showing simultaneously the locations of aircraft and birds in the corridor, to provide a “mapping of the sky”. The mapping can be used to monitor the corridor in order to prevent or reduce the interference of birds to aircraft in the corridor.

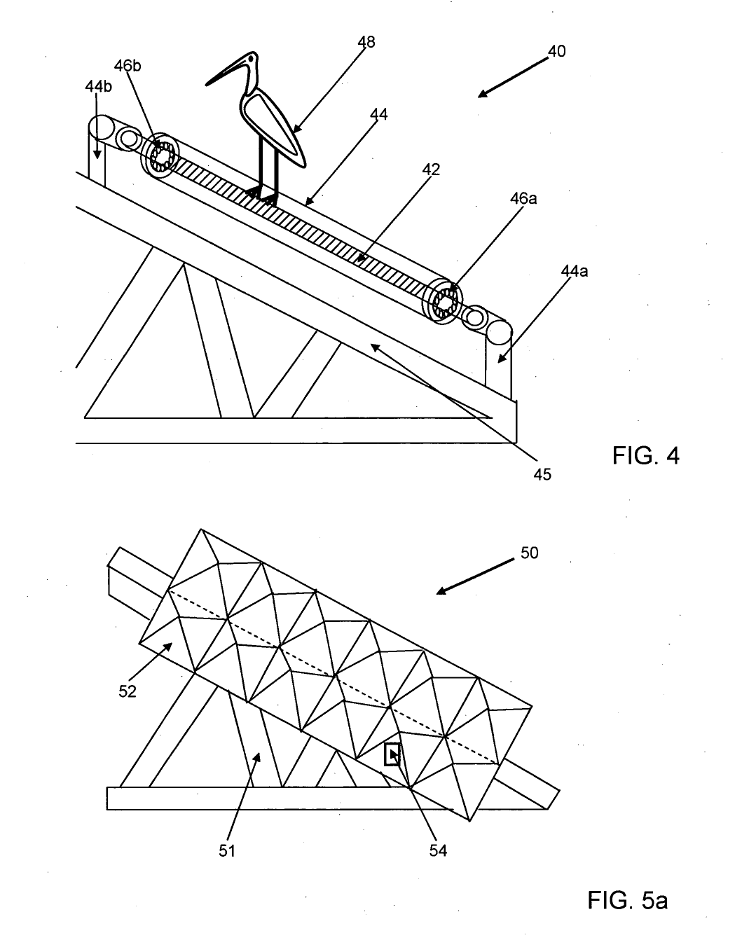

FIG. 4 shows a device 40 for preventing birds from perching or roosting, for example, on utility poles or runways, in accordance with this aspect of the invention. The device 40 comprises an axle 42 surrounded by a coaxial cylindrical tube 44. The axle 42 is supported at each end by vertical supports 44a and 44b, which in FIG. 4, are shown mounted on the top of a utility pole 45. The cylindrical tube 44 is free to rotate about the axle 42 by means of coaxial ball bearings 46a and 466 located at the ends of the tube. When a bird 48 attempts to perch on the cylindrical tube 44, the presence of the bird on the tube 44 generates a torque on the tube 44 causing the tube 44 to rotate. As the tube 44 rotates, the bird is caused to fall from the tube, and is thus prevented from perching on the tube.

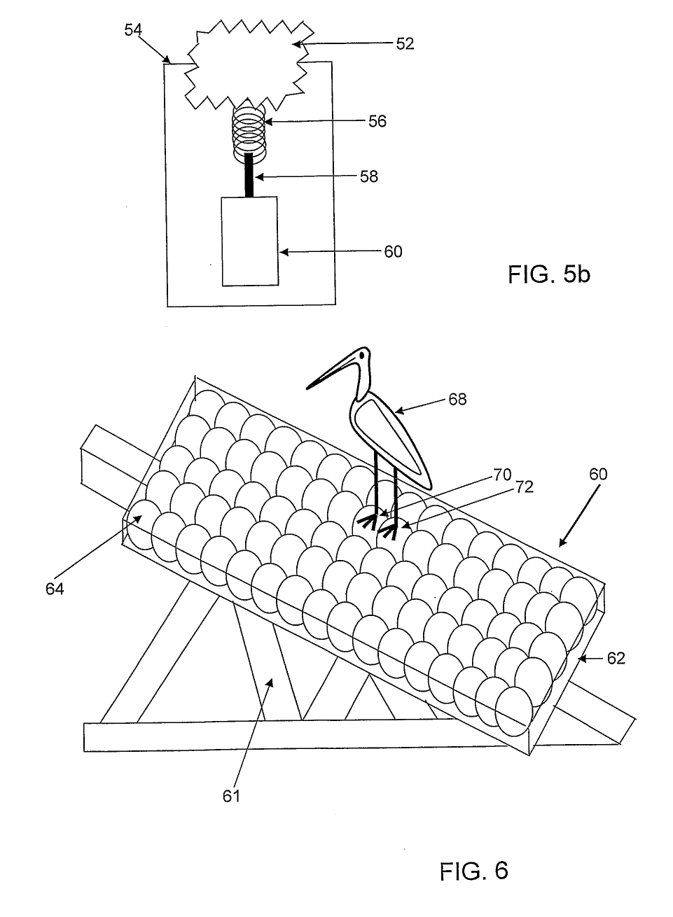

FIG. 5a shows another device 50 for preventing birds from perching or roosting, for example, on utility poles or runways. The device 50 is shown in FIG. 5a mounted on the top of a utility pole 51. The device 50 comprises an overlying flexible sheet 52 supported by a plurality of activation units 54. As shown in FIG. 5b each activation unit 54 includes a helical spring 56 an upper end of which is in contact with the flexible sheet. The helical spring 56 can be activated by a piston 58 of an electrical motor 60. When a bird attempts to perch on the flexible sheet 52, pressure sensors 62 associated with the sheet 52 detect the presence of the bird and activates the pistons 58 to execute an oscillatory motion. Activation of the pistons 58 drives an oscillatory motion of the springs 56 which in turn cause an oscillatory or shaking motion of the sheet 52. Shaking of the sheet 52 causes the bird to flee and thus prevents birds from perching on the sheet 52. In another embodiment, the pressure sensors, motors and pistons are omitted. In this embodiment, pressure of a bird on the flexible sheet causes helical springs to oscillate, which in turn causes the bird to flee and thus prevents birds from perching on the sheet.

FIG. 6 shows another device 60 for preventing birds from perching or roosting, for example, on utility poles or runways. The device 60 is shown in FIG. 5a mounted on the top of a utility pole 61. The device 60 comprises a rack 62 containing a plurality of light foam or plastic balls 64. When a bird 68 attempts to perch on the rack of balls, the presence of the bird on the balls upon which the bird is standing (the balls 70 and 72) generates a torque on the balls 70 and 72 causing the balls 70 and 72 to rotate. As the balls 70 and 72, the bird is caused to fall from the balls, and is thus prevented from perching on the balls.

1. A system for deterring intruding animals in a surveillance space or surveillance area comprising:
one or more detectors monitoring the surveillance space or area for the presence of intruding animals, each detector generating a signal;
one or more deterrence devices, at least one of the deterrence devices being positionable;
a processor configured to:
analyze the one or more detector signals in order to determine whether or not any intruding animals are located in the space under surveillance;
when an intruding animal is detected, to determine from the one or more detector signals; an azimuth and elevation of the intruding animal relative to a position of the system;
position one or more of the positionable deterrence devices to aim the one or more of the positionable deterrence devices at the intruding animal; and
activate the one or more aimed deterrence devices.

2. The system according to claim 1 wherein one or more of the detectors is selected from the group consisting of:
(a) a video camera (CCD);
(b) a thermal imaging camera;
(c) an ultraviolet (UV) camera having a sensitivity peak sensitivity in the range of 350 to 360 nm;
(d) a Radar device; and
(e) an antenna and microphone combination for detecting animal sounds;

3. The system according to claim 2 wherein the antenna and microphone combination for detecting animal sounds comprises a phased array of microphones.

4. The system according to claim 1 wherein the processor is further configured to determine a distance of the intruding animal to the system.

5. The system according to claim 1 comprising two or more detectors of different types.

6. The system according to claim 1, wherein the processor is further configured to:
(a) prioritize intruding animals when more than one intruding animal is detected simultaneously in the surveillance space, according to the risk of danger or damage posed by each intruding animal; and
(b) aim one or more of the positionable deterrence devices at the intruding animal or animals having the highest prioritization.

7. The system according to claim 6 wherein prioritization involves any one or more of a location of the animal, a direction and speed of the animal's movement, an azimuth of the animal's movement, a predicted time remaining until the intruding animal is expected to cause damage; and a density of intruding animals at a particular location.

8. The system according to claim 1 further comprising two or more deterrence devices of different types.

9. The system according to claim 1 wherein one or more of the detectors are positionable in unison with one or more of the positionable deterrence devices.

10. The system according to claim 1 wherein the positionable deterrence devices include a laser.

11. The system according to claim 10 wherein aiming the laser comprises rotating a mirror reflecting one or more beams from the laser.

12. The system according to claim 1 wherein the one or more deterrence devices includes an acoustic device.

13. The system according to claim 1 wherein the processor is further configured to generate an image showing simultaneously the locations of animals and other objects in the surveillance space.

14. A method for deterring intruding animals in a surveillance space or surveillance area comprising:
using one or more detectors to monitor the surveillance space or area for the presence of intruding animals, each detector generating a signal;
analyzing the one or more detector signals in order to determine whether or not any intruding animals are located in the space under surveillance;
when an intruding animal is detected, determining from the one or more detector signals an azimuth and elevation of the intruding animal;
aiming one or more positionable deterrence devices at the intruding animal; and
activating the one or more aimed deterrence devices.

15. The method according to claim 14 wherein one or more of the detectors is selected from the group consisting of:
(a) a video camera (CCD);
(b) a thermal imaging camera;
(c) an ultraviolet (UV) camera having a sensitivity peak sensitivity in the range of 350 to 360 nm;
(d) a radar device; and
(e) an antenna and microphone combination detecting animal sounds;

16. The method according to claim 15 wherein the antenna and microphone combination for detecting animal sounds comprises a phased array of microphones.

17. The method according to claim 14 further comprising analyzing one or more of the detector signals to determine a distance of the intruding animal.

18. The method according to claim 16 further comprising using two or more detectors of different types.

19. The method according to claim 1, further comprising:
(a) prioritizing intruding animals when more than one intruding animal is detected simultaneously in the surveillance space, according to the risk of danger or damage posed by each intruding animal; and
(b) aiming one or more of the positionable deterrence devices at the intruding animal or animals having the highest prioritization.

20. The method according to claim 19 wherein prioritizing intruding animals involves any one or more of a location of the animal, a direction and speed of the animals movement, an azimuth of the animal's movement, a predicted time remaining until the intruding animal is expected to cause damage; and a density of intruding animals at a particular location.

21. The method according to claim 14 further comprising using two or more deterrence devices of different types.

22. The method according to claim 14 further comprising positioning one or more of the detectors in unison with one or more of the positionable deterrence devices.

23. The method according to claim 14 wherein the positionable deterrence devices include a laser.

24. The method according to claim 23 wherein aiming the laser comprises rotating a mirror reflecting one or more beams from the laser.

25. The method according to claim 14 wherein the one or more deterrence devices includes an acoustic device.

26. The method according to claim 14, wherein the intruding animals are birds.

27. A method for deterring intruding animals from a landing and take-off corridor comprising deploying along the corridor one or more systems for deterring intruding animals.

28. The method according to claim 27 wherein the systems for deterring intruding animals are positioned along the corridor for a distance of about 10 miles from an end of a runway contiguous with the corridor.

29. The method according to claim 14 further comprising generating an image showing simultaneously the locations of animals and other objects in the surveillance space.

30. A system for deterring intruding animals in a surveillance space or surveillance area comprising:
two or more detectors for monitoring the surveillance space or area for the presence of intruding animals, each detector generating a signal;
one or more deterrence devices; and
a processor configured to analyze the two or more detector signals in order to determine whether or not any intruding animals are located in the space under surveillance.

31. A device for preventing birds from perching or roosting comprising:
(a) an axle; and
(b) a cylindrical tube coaxial with the axle, the cylindrical tube being rotatable around the axle.

32. A device for preventing birds from perching or roosting, comprising:
(a) a flexible sheet;
(b) one or more pressure sensors associated with the flexible sheet;
(c) one or more activation units, each activation unit including:
a helical spring having an end in contact with the flexible sheet;
an electrical motor configured to generate motion of the helical spring when one or more of the pressure sensors are activated.

33. A device for preventing birds from perching or roosting, comprising a rack containing a plurality of balls.
